(19) United States
(12) Patent Application Publication
(10) Pub. No.: US 2008/0247792 A1
(43) Pub. Date: Oct. 9, 2008

(54) IMAGE FORMING APPARATUS

(75) Inventor: Tomoaki Kubo, Izunokuni-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/696,497

(22) Filed: Apr. 4, 2007

(51) Int. Cl. G03G 15/00

(52) U.S. Cl. 399/377

(57) ABSTRACT

In an image forming apparatus having driving conditions for plural image forming modes such as color and monochrome, when an original with a blank sheet (inter-sheet) inserted at an arbitrary position therein is to be printed, the image forming mode for the position where the blank sheet is inserted is properly determined and a transfer belt is caused to contact and separate from an image carrier related to image formation, thereby improving printing productivity.

### BACKGROUND OF THE INVENTION

1. Field of the Invention

The present invention relates to an image forming apparatus having driving conditions for plural image forming modes such as color and monochrome, and particularly to an image forming apparatus in which, when an original with a blank sheet (inter-sheet) inserted at an arbitrary position therein is to be printed, the image forming mode for the position where the blank sheet is inserted is properly determined and set, thereby improving the productivity of printing.

2. Description of the Related Art

In the case of collectively copying and printing an original of plural sheets by an image forming apparatus, a blank sheet (inter-sheet) that is not to be printed, such as a cover, partition or tab sheet, may be inserted at an arbitrary position.

Therefore, an image forming apparatus such as an electrophotographic digital copying machine or printer has a function of inserting a blank sheet (inter-sheet) that is not to be printed, such as a cover, partition or tab sheet, at an arbitrary position among the recording sheets to be discharged in accordance with an instruction made by a user's operation of a control panel or an instruction made by an operation of an information terminal via a printer driver.

For example, the user operates an operating unit of the image forming apparatus to input and set a page where an inter-sheet should be inserted, as “blank sheet insertion”, at each position. (See, for example, JP-A-2006-201696.)

In the case where the machine type of the image forming apparatus supports a color mode and a monochrome mode as image forming modes, when a blank sheet is to be inserted, an operation of inserting a blank sheet is carried out in accordance with predetermined driving conditions (image forming mode conditions), or if the driving conditions for all the printed matter are the same, in accordance with the driving conditions of the image forming mode.

Generally, when the driving conditions in the image forming apparatus such as the carrying speed, printing speed and resolution are to be switched, the print sequence is temporarily stopped and then the image forming speed, the sheet carrying speed and the number of rotations of the polygon motor are switch-controlled. After that, the apparatus has to wait for various motors to stabilize.

In the image forming apparatus that characteristically has plural driving conditions and takes time for switching the driving conditions, switching is frequency required in accordance with the driving conditions for a sheet to be printed and a blank sheet. As a result, there arise problems of lowering of image forming performance and degradation in the mechanical units.

### BRIEF SUMMARY OF THE INVENTION

It is an object of the present invention to provide an image forming apparatus that has plural driving conditions for a color mode and a monochrome mode and selects a proper blank sheet driving condition from the driving conditions before and after the insertion of a blank sheet.

In an aspect of the present invention, an image forming apparatus includes:

image reading means for reading an image from an original;

a developing unit having plural image carriers to form the image of the original read by the image reading means;

an endless transfer belt that can contact and separate from the image carriers; and

contact and separation means for causing the transfer belt to contact the image carrier related to image formation and to separate from the image carrier that is not related to the image formation, in accordance with plural image forming modes having different numbers of the image carriers to be used for image formation;

wherein when a blank sheet is inserted at an intermediate position in the original of plural sheets read by the image reading means, the contact and separation means operates to start printing in accordance with an image forming mode corresponding to an image immediately before the blank sheet.

### BRIEF DESCRIPTION OF THE DRAWINGS

FIG. 1 is a side sectional view showing a schematic configuration of an image forming apparatus according to an embodiment of the invention.

FIG. 2A is an enlarged side sectional view showing an exemplary operation corresponding to an image forming mode in an image forming unit of the image forming apparatus.

FIG. 2B is an enlarged side sectional view showing an exemplary operation corresponding to an image forming mode in the image forming unit of the image forming apparatus.

FIG. 3 is an explanatory view of a moving mechanism of the image forming unit of the image forming apparatus.

FIG. 4 is an explanatory view of the moving mechanism of the image forming unit of the image forming apparatus.

FIG. 5 is a block diagram showing connection of hardware of the image forming apparatus.

FIG. 6 is a flowchart showing a basic print process in the image forming apparatus.

FIG. 7 is a flowchart in the case of inserting a blank sheet in the image forming apparatus.

FIG. 8 is an explanatory view for explaining a state where plural blank sheets are used.

### DETAILED DESCRIPTION OF THE INVENTION

Throughout this description, the embodiments and examples shown should be considered as exemplars, rather than limitations on the apparatus and methods of the present invention.

Hereinafter, an embodiment of the invention will be described with reference to the drawings.

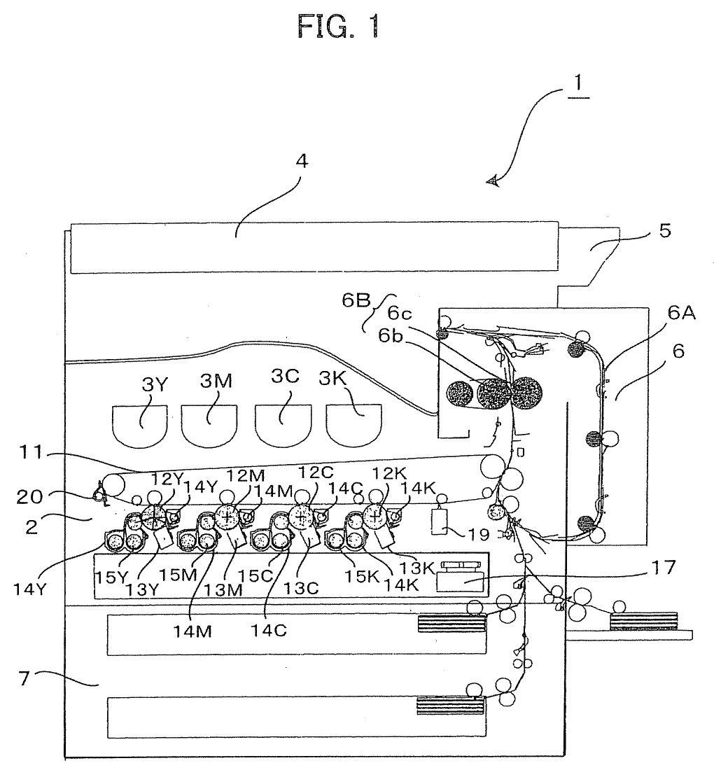

FIG. 1 is a side sectional view showing a schematic configuration of an image forming apparatus. As shown in FIG. 1, as a basic layout of each unit that forms an image forming apparatus 1, an image forming unit 2 is arranged substantially at a central part of the apparatus body. An internal paper discharge unit 6 is arranged to the lateral side of this image forming unit 2. Also, toner cartridges 3Y, 3M, 3C and 3k for respective colors are housed and arranged above the image forming unit 2. An original reading unit 4 is arranged above these toner cartridges 3Y, 3M, 3C and 3K. Also, an automatic document feeder (ADF) 5 is arranged to the lateral side of the original reading unit 4. An operating unit and a display unit (not shown) are formed above the original reading unit 4. Also, a paper feeder unit 7 is provided below the image forming unit 2.

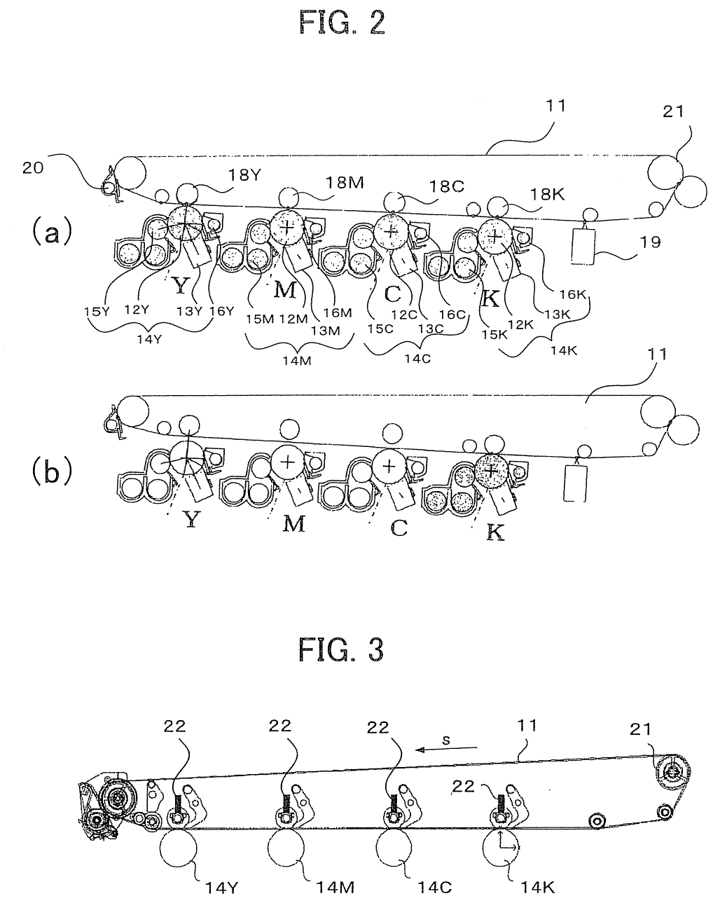

FIG. 2A and FIG. 2B are enlarged side sectional views of the image forming unit. FIG. 2A shows a case where image formation of all the four colors is carried out (a color mode, which is a multiple-color image forming mode). FIG. 2B shows a case where image formation of only black is carried out (a monochrome mode, which is a single-color image forming mode). In FIG. 2A and FIG. 2B, the subscript letters (Y, M, C, K) to the respective numerals show that they are parts for yellow, magenta, cyan, and black. These parts differ only in the color of toner housed in the developing unit, and have the same configuration. The image forming unit 2 is of a tandem system and is configured with developing units 14Y, 14M, 14C and 14K having photoconductive drums 12Y, 12M, 12C and 12K as four image carriers, linearly arrayed facing a belt carrying surface (outer circumferential surface) of an endless transfer belt 11 made of, for example, semiconducting polyimide.

The developing units 14Y, 14M, 14C and 14K have the photoconductive drums 12Y, 12M, 12C and 12K, chargers 13Y, 13M, 13C and 13K, developing devices 15Y, 15M, 15C and 15K, and cleaners 16Y, 16M, 16C and 16K corresponding to the respective toner colors C (cyan), Y (yellow), M (magenta) and K (black). A predetermined gap is provided between the chargers 13Y, 13M, 13C, 13K and the developing devices 15Y, 15M, 15C, 15K in the casings of these developing units 14Y, 14M, 14C and 14K. Via this gap, the circumferential surfaces of the photoconductive drums 12Y, 12M, 12C and 12K1 are exposed to and irradiated with light by exposure means 17 (shown in FIG. 1) formed by a laser scanner or LED. The chargers 13Y, 13M, 13C and 13K evenly charge the circumferential surfaces of the corresponding photoconductive drums 12Y, 12M, 12C and 12K with predetermined electric charges. The exposure means 17 exposes to light the charged circumferential surfaces of the photoconductive drums 12Y, 12M, 12C and 12K in accordance with image information and thus forms electrostatic latent images thereon. Then, the developing devices 15Y, 15M, 15C and 15K transfer toner corresponding to the formed electrostatic latent images and thus form (develop) toner images.

Also, transfer members 18Y, 18M, 18C and 18K are arranged to the other side of the carrying surface of the transfer belt 11. The toner images formed (developed) on the circumferential surfaces of the photoconductive drums 12Y, 12M, 12C and 12K are transferred onto the surface of the transfer belt 11 carried thereto, by transfer fields formed by the corresponding transfer members (primary transfer rollers) 18Y, 18M, 18C and 18K. The transfer members 18Y, 18M, 18C and 18K are respectively movable in the direction of an arrow A by a moving mechanism, which will be described later, and they contact and separate from the transfer belt 11 in accordance with the image forming mode (color mode or monochrome mode). Also, interlocked with this contact and separation, the transfer belt 11 contacts and separates from the photoconductive drums 12Y, 12M, 12C and 12K.

That is, in the case of the color image forming mode, all the transfer members 18Y, 18M, 18C and 18K contact the transfer belt 11. On the other hand, in the case of the monochrome image forming mode, only the black transfer member 18K contacts the transfer belt 11.

The photoconductive drums 12Y, 12M, 12C and 12K are driven separately and individually. Indexes (not shown) are installed in the photoconductive drums 12Y, 12M, 12C and 12K, and they generate one pulse per rotation of the photoconductive drums 12Y, 12M, 12C and 12K. At which position in one rotation the photoconductive drums 12Y, 12M, 12C and 12K are situated, is detected by a home position detector (not shown) that detects a predetermined home position, and the rotation is controlled with the result of the detection.

Also, a registration detection sensor 19 provided facing the belt carrying surface (outer circumferential surface) of the transfer belt 11 is a sensor that detects the state of alignment (registration deviation) in superimposing the respective colors. Also, a transfer belt cleaner 28 is arranged facing the belt carrying surface (outer circumferential surface) of the transfer belt 11.

Next, a contact and separation mechanism will be described that causes the above transfer members 18Y, 18M, 18C and 18K to contact and separate from the transfer belt 11 and thus causes the transfer belt 11 to contact and separate from the photoconductive drums 12Y, 12M, 12C and 12K.

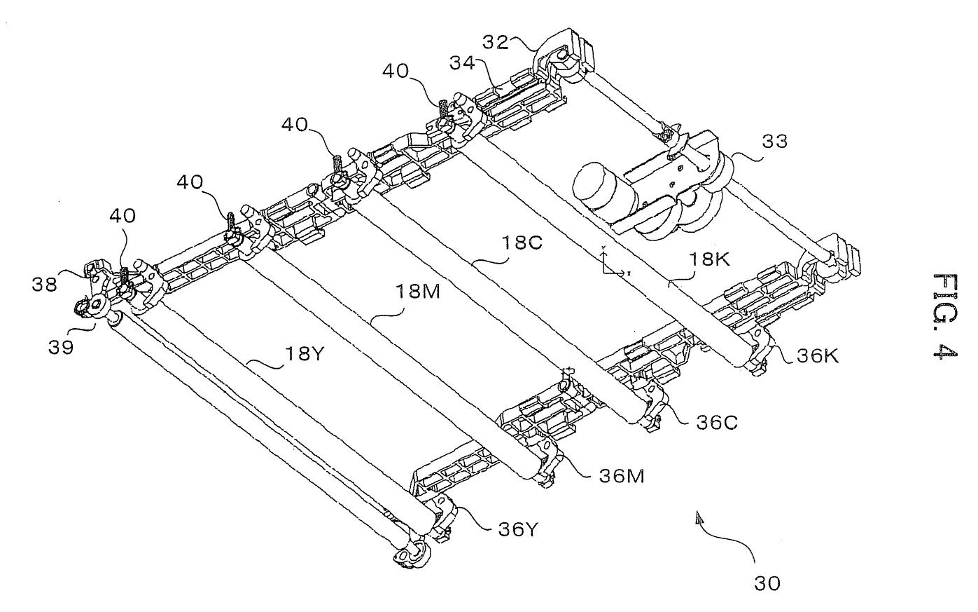

FIG. 3 is an explanatory view for schematically explaining the layout of the transfer members 18Y, 18M, 18C, 18K facing the transfer belt 11, and the contact and separation mechanism. The transfer belt 11 is driven by a driving roller 21 and travels in the direction of an arrow S. A bias voltage is applied to the transfer members 18Y, 18M, 18C and 18K, which are the primary transfer rollers arranged at the positions facing the photoconductive drums 12Y, 12M, 12C and 12K, and the toner images developed on the surface of the photoconductive drums 12Y, 12M, 12C and 12K are transferred onto the surface of the transfer belt 11. In this case, with their own weights and the pressurization by compression springs 22, the transfer members 18Y, 18M, 18C and 18K press the transfer belt 11 to the photoconductive drums 12Y, 12M, 12C and 12K while forming predetermined nipping parts.

FIG. 4 is a perspective view of the separation mechanism, as viewed from the bottom, for explaining the separation of the transfer belt 11 from the photoconductive drums 12Y, 12M, 12C and 12K due to the movement of the transfer members 18Y, 18M, 18C and 18K facing the transfer belt.

That is, a separation mechanism 30 includes a cam 32, a driving system 33 for operating the cam 32, links 34 and 35, lifters 36Y, 36M, 36C and 36K, a belt stretching roller 37, a roller cam 38, and a roller holder 39.

The link 34 is to drive the black (K) primary transfer roller (transfer member) 18K, and the link 35 is to drive the color primary transfer rollers 18Y, 18M, 18C and 18K. The link 34 moves the lifter 36K, and the link 35 moves the lifters 36Y, 36M, 36C and 36K. The roller holder 39 is energized upward by a tension spring.

The cam 32 is rotated by the driving system 33, and the lifters 36Y, 36M, 36C and 36K rotate via the links 34 and 35. The hooks at the ends of the lifters 36Y, 36M, 36C and 36K lift the primary transfer rollers 18Y, 18M, 18C and 18K. At the same time, the roller cam 38 rotates and the roller holder 39 is lifted by tension springs 40, thus causing the transfer belt 11 to separate from the photoconductive drums 12Y, 12M, 12C and 12K.

With these configurations, in the color mode, that is, the multi-color image forming mode to which the plural photoconductive drums 12Y, 12M, 12C and 12K are related, all the photoconductive drums 12Y, 12M, 12C and 12K related to color image formation are in contact with the transfer belt 11, as shown in FIG. 2A. On the other hand, in the monochrome mode, that is, the single-color image forming mode to which the single photoconductive drum 12K is related, only the photoconductive drum 13K is in contact with the transfer belt 11 and the photoconductive drums 13Y, 13M and 13C that are not related to the image formation are separated from the transfer belt 11, as shown in FIG. 2B.

The toner cartridges 3Y, 3M, 3C and 3K are attachable and toners of the respective colors of yellow (Y), magenta (M), cyan (C) and black (K) are housed therein.

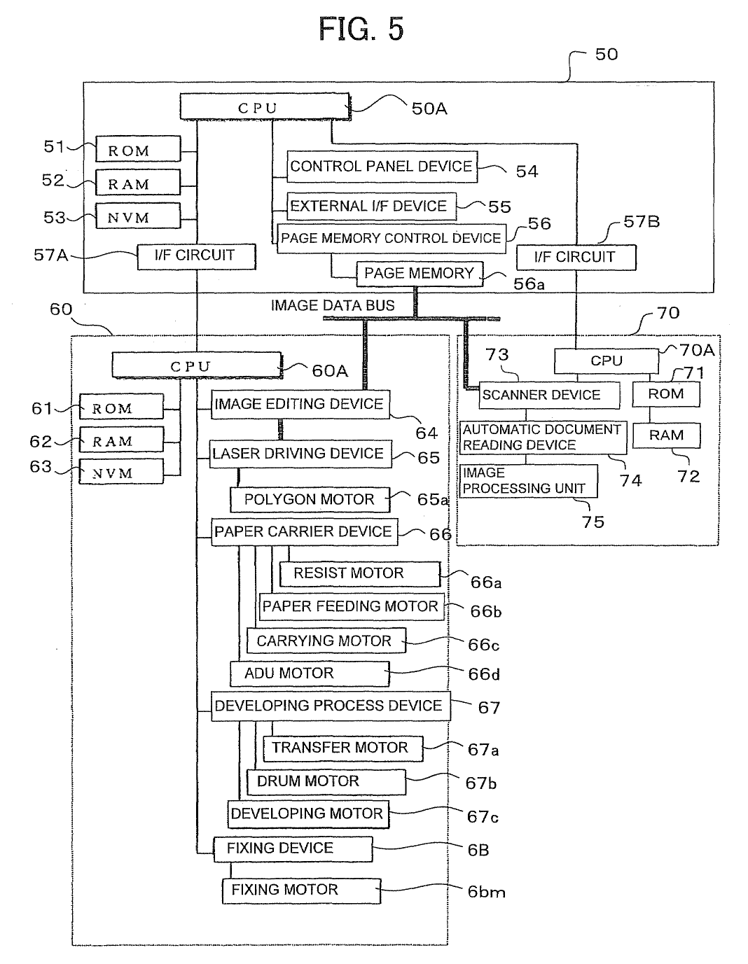

In the original reading unit 4, an original fed by an automatic document feeder device 74 shown in FIG. 5 is sequentially read by a scanner device 73 and sent to an image processing unit 75. In the image processing unit 75, the original is stored as image data into an image data file provided as storage means, and predetermined image processing is performed on this image data.

Also, the original reading unit 4 has an automatic document feeder (ADF) not shown, reads each sheet of an original including plural sheets set on the ADF, and generates image data. One side or both sides of an original can be read in accordance with the user's instruction.

An automatic duplex unit (ADU) 6A provided in the internal paper discharge unit 6 is a mechanism to reverse the side of one sheet at the time of printing. That is, there is a double-side copying function to print on both sides of a sheet as a copying function. In double-side copying, after printing is done on one side of a sheet fed from the cassette that houses sheets, the sheet is carried to the ADU 6A to reverse the side of the sheet and printing is done on the other side, thus making print on both sides of the sheet. The double-side copying to print on both sides of a sheet includes “one side to double side” copying, in which one side of the original is read and copied to both sides of the sheet, and “double side to double side” copying, in which both sides of the original are read and copied to both sides of the sheet.

Even though the ADU 6A is loaded, in one-side copying, the sheet after printing on its one side is discharged through a route in the internal paper discharge unit, without being carried to the ADU 6A. The one-side copying to print on one side of a sheet includes “one side to one side” copying, in which one side of the original is read and copied to one side of the sheet, and “double side to one side” copying, in which both sides of the original are read and copied to one side of the sheet.

A fixing unit 6B is formed in the internal paper discharge unit 6, and it is formed by a heat roller 6b and a press-contact roller 6c facing the heat roller.

Also, the paper feeder unit 7 is provided below the image forming unit 2. Plural paper feed cassettes 7a and 7b housing sheets of various sizes are provided in the paper feeder unit 7. Moreover, a manual insertion paper feeder unit 7c that feeds a sheet paper by manual insertion is provided therein.

FIG. 5 is a block diagram showing the connection of hardware related to the image forming apparatus. The control system of the image forming apparatus 1 of the above configuration will be described with reference to FIG. 5.

Roughly, the control system has a system unit 50, an engine unit 60, and a scanner unit 70.

A system CPU 50A of the system unit 50 is connected to a ROM 51, a RAM 52, and a NVRAM (non-volatile memory) 53, and is also connected to a control panel device 54, an external I/F device 55 for network connection, a page memory control device 56 that controls a page memory 56a, and I/F circuits 57A and 57B that are connected to the engine unit 60 and the scanner unit 70, respectively.

In the system unit 50, the system CPU 50A drives the units 51 to 57 forming the system unit 50, in accordance with control programs stored in the ROM 51 and an HDD (not shown). The system CPU also receives status information sent from an engine CPU 60A of the engine unit 60 and a scanner CPU 70A of the scanner unit 70, and input information inputted from the control panel device 54, and controls the entire image forming apparatus 1.

The engine CPU 60A of the engine unit 60 is connected to a ROM 61, a RAM 62, a NVRAM 63, an image editing device 64, a laser driving device 65 that drives a polygon motor 65a, a paper feeder device 66 having a resist motor 66a, a paper feeding motor 66b, a carrying motor 66c and an ADU motor 66d, a developing process device 67 having a transfer motor 67a, a drum motor 67b and a developing motor 67c, and the fixing device 6B having a fixing motor 6bm, and controls these units.

The scanner CPU 70A of the scanner unit 70 is connected to a ROM 71, a RAM 72, the scanner device 73, the automatic document feeder device 74, and the image processing device 75. In the scanner unit 70, the scanner CPU 70A drives each part of the scanner (not shown) and performs control related to image reading, by using the memories 71 and 72.

Next, a basic printing operation for image formation in the full-color image forming apparatus 11 of the above configuration will be described.

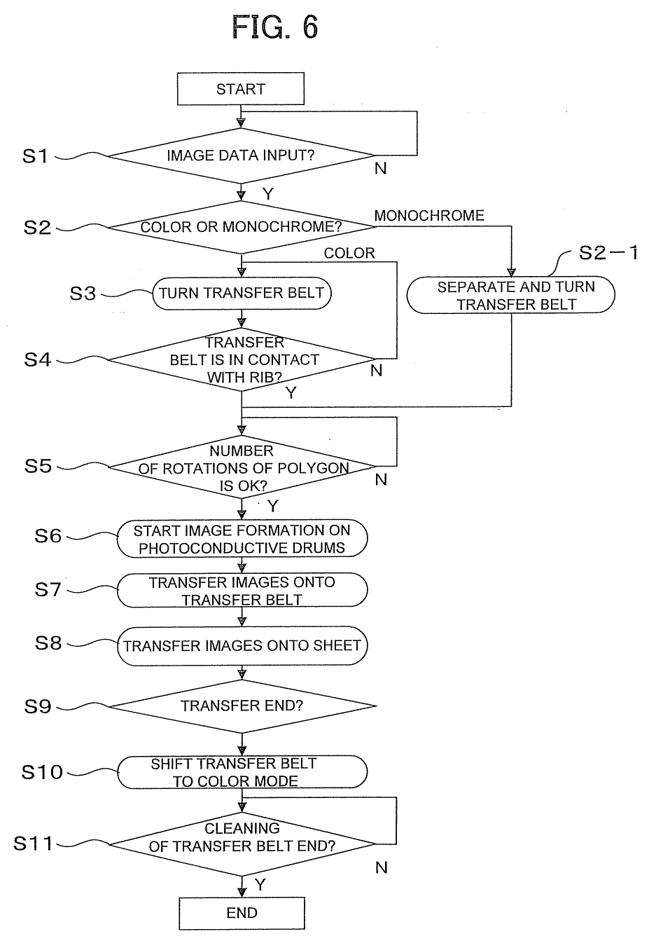

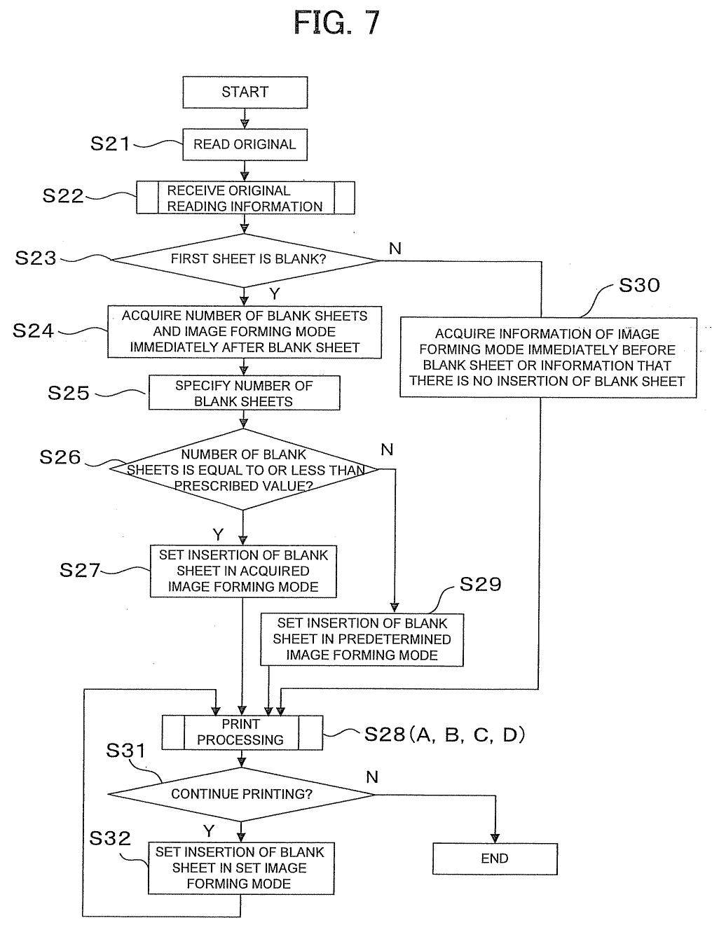

FIG. 6 is a basic flowchart of the image forming operation.

First, an original set on an original table (not shown) by the document feeder device 5 and the like is optically read by the original reading unit 4 and its image data is transmitted to the exposure means 17 of the image forming unit 2 (the image data is inputted to the image forming apparatus 1) (step S1).

It is determined whether the image data is a monochrome image or color image (step S2).

In the case of a color image (color mode), driving of the transfer belt 11, the photoconductive drums 12Y, 12M, 12C and 12K, and the polygon motor (not shown) of the exposure means 17 is started (step S3).

In this case, since it is the color mode and a color deviation is generated by a misalignment, alignment correction of the transfer carrier belt 11 is carried out (whether it is in contact with the rib or not) (step S4) In the case of a monochrome image (monochrome mode) the transfer belt 11 is separated, in addition to starting driving of the transfer belt 11, the photoconductive drums 12Y, 12M, 12C and 12K, and the polygon motor (not shown).

In this case, since it is the monochrome mode and no color deviation occurs even if there is a misalignment, alignment correction of the transfer belt 11 is not carried out (step S2-1).

It is determined whether the number of rotations of the polygon motor has reached a predetermined number of rotations or not, after the transfer carrier belt 11 contacts the rib (not shown) in the case of the color mode, or after the transfer belt 11 is separated in the case of the monochrome mode (step S5).

When the predetermined number of rotations has reached, the exposure means 17 scans a laser beam from a laser oscillating unit (not shown) with a polygon mirror in accordance with the image signal, then causes the laser beam to pass through several optical lenses (not shown), guides the optical path with a folding mirror, and casts the laser beam to the photoconductive drums 12Y, 12M, 12C and 12K. As the photoconductive drums 12Y, 12M, 12C and 12K rotate synchronously with the image signal read by the original reading unit 4, latent images are formed on the photoconductive drums 12Y, 12M, 12C and 12K by the scanning laser beam from the exposure means 17 (step S6).

The latent images formed on the photoconductive drums 12Y, 12M, 12C and 12K are made visible (developed) with toner by the developing units 14Y, 14M, 14C and 14K3 as developing means. The images, thus made visible, are transferred onto the transfer belt 11, which is an endless belt, by the transfer members (primary transfer rollers) 18Y, 18M, 18C and 18K (step S7).

In the case of the monochrome mode, the above operation is carried only for black. In the case of the color mode, the above process is continuously carried out for each color of yellow, cyan, magenta, and black, and as the transfer belt 11 moves in the direction of the arrow S at a constant process speed, the toner images of the respective colors are sequentially superimposed and transferred to the transfer belt 11.

Meanwhile, recording sheets (not shown), which are transfer materials, are stacked in the feed cassettes 7a and 7b. A recording sheet is picked up by a feed roller and carried along a recording sheet carrying path by plural carrier rollers (not shown). Then, the toner images of the respective colors transferred on the transfer belt are transferred to the transfer sheet (recording sheet) (step S8).

After that, as heat and pressure are applied by the fixing unit 6B, the toner images of the respective colors are fixed on the transfer sheet, which is then discharged.

If it is determined that the transfer to the recording sheet ends (step S9), cleaning of the photoconductive drum 12Y, 12M, 12C and 12K1, and the transfer belt 11 is started. Then, the transfer belt 11 is constantly shifted to the color mode side within this cleaning time (step S10).

That is, in the case where image formation has been carried out in the monochrome mode, the transfer belt 11 is moved to contact the photoconductive drums 12Y, 12M, 12C and 12K. On the other hand, in the case where image formation has been carried out in the color mode, the transfer belt 11 is maintained in contact with the photoconductive drums 12Y, 12M, 12C and 12K.

The toner remaining on the surfaces of the photoconductive drums 12Y, 12M, 12C and 12K is collected by the cleaning units 16Y, 16M, 16C and 16A, and the photoconductive drums 12Y, 12M, 12C and 12K are cleaned.

Also, the toner remaining on the transfer belt 11 is collected by a transfer carrier belt cleaner (not shown) and the transfer belt 11 is cleaned. At the time when the cleaning of the transfer carrier belt 11 is completed, the print job ends (step S11).

Next, a process in the case of inserting a blank sheet after automatic reading of an original in the full-color image forming apparatus 1 of the above configuration will be described. In a “print processing” step in the process where a blank sheet is inserted, the print operation described above with reference to FIG. 6 (step S3 and the subsequent steps) is carried out.

The basic ideas to efficiently carry out the process of inserting a blank sheet include the following.

(1) In the case where a blank sheet is inserted on the first sheet of the original, the image forming mode (color or monochrome mode) for the sheet after the blank sheet is determined and printing is carried out in the determined image forming mode.

(2) In the case where a blank sheet is inserted on the second or subsequent sheet of the original, the image forming mode (color or monochrome mode) for the sheet before the inserted blank sheet is determined and printing is carried out in the determined image forming mode.

FIG. 7 is a flowchart of the process in the case of inserting a blank sheet after automatic reading of an original in the full-color image forming apparatus 1. In the section of “print processing” in the flowchart of FIG. 7, the image forming processing in the image forming process shown in FIG. 6 is carried out as described above (step S3 and the subsequent steps).

First, an original set on the original table (not shown) by the document feeder device 5 and the like is optically read by the original reading unit 4 and the result of reading is stored into a storage unit (step S21) As the original is read, the information of the original is received by the system unit 50 (step S22).

From the received information, it is determined whether the first sheet of the original is blank or not (step S23).

### [Flow in the Case Where the First Sheet is Blank]

When it is determined that the first sheet of the original is blank, information about how many blank sheets are included is received, and the image forming mode after the blank sheet is acquired (step S24).

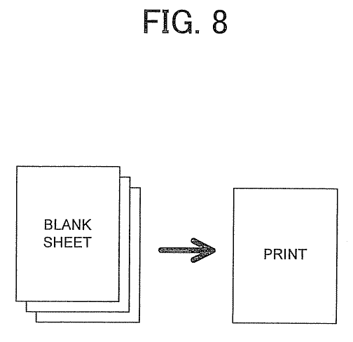

As shown in the schematic diagram of FIG. 8, the number of blank sheets is specified (step S25).

It is determined whether the number of blank sheets is equal to or less than a prescribed number of sheets that is predefined in accordance with the memory capacity in order to prevent memory errors (step S26).

If the number of blank sheets is equal to or less than the prescribed number, the system unit 50 sets insertion of blank sheets in the image forming mode acquired in step S24 (step S27).

In the image forming mode set in step S27, print processing is carried out in accordance with an instruction from the system unit 50 (step S28A).

On the other hand, if it is determined in step S26 that the number of blank sheets is not equal to or less than the prescribed number, the system unit 50 sets insertion of blank sheets in a predetermined image forming mode (step S29).

In the image forming mode set in step S29, print processing is carried out in accordance with an instruction from the system unit 50 (step S28B).

[Flow in the Case where the First Sheet is Not Blank]

If it is determined in step S23 that the first sheet of the original is not blank, information about the image forming mode before the blank sheet inserted in the plural sheets of the original, is acquired, or information that there is no insertion of a blank sheet is acquired (step S30)

On the basis of the acquired information about the image forming mode before the blank sheet or the information that there is no insertion of a blank sheet, print processing is carried out in accordance with an instruction from the system unit 50 (step S28C).

### [Flow of Continuation of Printing]

It is determined whether continuation of printing is possible or not (step S31).

If printing is to be continued, the system unit 50 sets insertion of a blank sheet in accordance with the information about the image forming mode acquired and set in the above processes (step S32).

Print processing is carried out in accordance with an instruction from the system unit 50 (step S28D).

After the printing ends, the processing returns to step S31 again and it is determined whether continuation of printing is possible or not. This is repeated, and when continuation of printing is impossible, the printing ends.

If continuation of printing is impossible in step S31, the printing ends.

According to the above processes, since the image forming mode need not be changed every time a blank sheet is inserted, the image processing process can be carried out efficiently without lowering the productivity of the image forming apparatus even in the process where a blank sheet is inserted.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. An image forming apparatus comprising:
image reading means for reading an image from an original;
a developing unit having plural image carriers to form the image of the original read by the image reading means;
an endless transfer belt that can contact and separate from the image carriers; and
contact and separation means for causing the transfer belt to contact the image carrier related to image formation and to separate from the image carrier that is not related to the image formation, in accordance with plural image forming modes having different numbers of the image carriers to be used for image formation;
wherein when a blank sheet is inserted at a starting position in the original of plural sheets read by the image reading means, the contact and separation means operates to start printing in accordance with an image forming mode corresponding to an image immediately after the blank sheet.

2. An image forming apparatus comprising:
image reading means for reading an image from an original;
a developing unit having plural image carriers to form the image of the original read by the image reading means;
an endless transfer belt that can contact and separate from the image carriers; and
contact and separation means for causing the transfer belt to contact the image carrier related to image formation and to separate from the image carrier that is not related to the image formation, in accordance with plural image forming modes having different numbers of the image carriers to be used for image formation;
wherein when a blank sheet is inserted at an intermediate position in the original of plural sheets read by the image reading means, the contact and separation means operates to start printing in accordance with an image forming mode corresponding to an image immediately before the blank sheet.

3. An image forming apparatus comprising:
image reading means for reading an image from an original;
a developing unit having plural image carriers to form the image of the original read by the image reading means;
an endless transfer belt that can contact and separate from the image carriers; and
contact and separation means for causing the transfer belt to contact the image carrier related to image formation and to separate from the image carrier that is not related to the image formation, in accordance with plural image forming modes having different numbers of the image carriers to be used for image formation;
wherein when a predetermined number of blank sheets are continuously inserted from a first sheet of the original of plural sheets read by the image reading means, the contact and separation means operates to start printing in accordance with a preset image forming mode.

4. The image forming apparatus according to claims 1 to 3, further comprising control means for controlling the contact and separation means, wherein the control means can identify status of the contact and separation means immediately after a blank sheet is inserted in the original.

5. The image forming apparatus according to claim 3, wherein the predetermined number of sheets is decided in accordance with capacity of a storage device that stored reading information of the original.
